(19) United States
(12) Patent Application Publication
(10) Pub. No.: US 2013/0269349 A1
(43) Pub. Date: Oct. 17, 2013

(54) SYSTEM AND METHOD FOR RECIRCULATING A VENTED FUEL TO A FUEL DELIVERY SYSTEM

(71) Applicant: Easwaran Rathinam, Bangalore (IN)

(72) Inventor: Easwaran Rathinam, Bangalore (IN)

(73) Assignee: GENERAL ELECTRIC COMPANY, Schenectady, NY (US)

(21) Appl. No.: 13/447,400

(22) Filed: Apr. 16, 2012

(51) Int. Cl. F02C 7/22

(52) U.S. Cl. 60/734; 137/565.17; 137/565.15; 137/1

(57) ABSTRACT

A system for recirculating a vented fuel to a fuel delivery system of a gas turbine generally includes a vented fuel conduit in fluid communication with the fuel delivery system and a container in fluid communication with the vented fuel conduit. A pump is disposed downstream from the container and a fuel conduit is disposed downstream from the pump. The fuel conduit may provide fluid communication from the pump to the fuel delivery system.

### FIELD OF THE INVENTION

The present invention generally involves a system and method for recirculating a vented fuel to a fuel delivery system. In particular embodiments of the present invention, a pump may draw the vented fuel from a vented fuel conduit through one or more fuel conduits providing fluid communication between the pump and the fuel delivery system.

### BACKGROUND OF THE INVENTION

Gas turbines typically include one or more combustors to generate power or thrust. A typical gas turbine used to generate electrical power includes an axial compressor at the front, one or more combustors around the middle, and a turbine at the rear. Ambient air may be supplied to the compressor and rotating blades and stationary vanes in the compressor progressively impart kinetic energy to the working fluid (air) to produce a compressed working fluid at a highly energized state. The compressed working fluid exits the compressor and flows through one or more nozzles in each combustor. A fuel supply system typically provides a pressurized fuel from a fuel supply to the one or more fuel nozzles in the combustor through a series of valves and fluid conduits. The compressed working fluid mixes with the pressurized fuel and ignites to generate combustion gases having a high temperature, pressure, and velocity. The combustion gases expand in the turbine to produce work. For example, expansion of the combustion gases in the turbine may rotate a shaft connected to a generator to produce electricity.

In certain situations, such as a controlled shutdown or a sudden trip of the gas turbine, the fuel supply system may vent the pressurized fuel through one or more vent valves to purge the fuel delivery system of unburned fuel. Typically, the pressurized fuel is vented into the atmosphere. However, other methods for disposing of the vented fuel have included flowing the vented fuel to a flare system that burns the vented fuel and then vents combustion byproducts to the atmosphere. As a result, the pressurized fuel and/or the combustion byproducts may have an adverse effect on the environment around the gas turbine. Therefore, a system and a method for recirculating the vented fuel back to the fuel delivery system to reduce the environmental impact caused by venting fuel to the atmosphere and/or burning the vented fuel would be useful.

BRIEF DESCRIPTION OF THE INVENTION

Aspects and advantages of the invention will be set forth in part in the following description, or may be obvious from the description, or may be learned through practice of the invention.

One embodiment of the present invention is a system for recirculating a vented fuel to a fuel delivery system of a gas turbine. The system generally includes a vented fuel conduit in fluid communication with the fuel delivery system, a container in fluid communication with the vented fuel conduit, a pump downstream from the container and a fuel conduit downstream from the pump. The fuel conduit may provide fluid communication from the pump to the fuel delivery system.

Another embodiment of the present invention may include a system for recirculating a vented fuel to a fuel delivery system for a combustor. The system may include a vented fuel conduit in fluid communication with the fuel delivery system and a container that is in fluid communication with the vented fuel conduit. The system also includes means for streaming the vented fuel to the fuel delivery system, wherein the means is in fluid communication with the container.

The various embodiments of the present disclosure may also provide a method for recirculating a vented fuel to a fuel delivery system. The method generally includes flowing the vented fuel into a container downstream from the fuel delivery system, pumping the vented fuel from the container through a pump downstream from the container, and flowing the vented fuel from the pump through a fuel conduit that provides fluid communication between the pump and the fuel supply system.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a schematic of a gas turbine including a system for recirculating a vented fuel to a fuel delivery system, according to the present disclosure; and

FIG. 2 provides a schematic of the system for recirculating a vented fuel to a fuel delivery system according to one embodiment of the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. In addition, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a system and a method for recirculating a fuel vented from a fuel delivery system of a gas turbine back to the fuel delivery system. In general, the system for recirculating vented fuel includes a vented fuel conduit in fluid communication with the fuel delivery system, a container in fluid communication with the vented fuel conduit, a pump downstream from the container, a check valve downstream from the pump and one or more fuel conduits providing fluid communication from the check valve to fuel delivery system. In operation, the pump provides a constant negative pressure in the container and/or the vented fuel conduit while the gas turbine is operating and/or the fuel delivery system is providing fuel to the combustor for combustion. During certain events, such as a controlled shutdown and/or a sudden uncontrolled shutdown of the gas turbine, also known in the industry as a “trip” event, the fuel delivery system allows pressurized fuel to vent from the combustor and/or the fuel delivery system in order to purge fuel supply lines and to prevent stagnation of the fuel within the combustor. The vented fuel flows from the fuel delivery system through multiple fluid conduits to the vented fuel conduit. The negative pressure in the container draws the vented fuel from the vented fuel conduit into the container. The fuel may then flow through the pump, through the check valve and back to the fuel delivery system. In particular embodiments, a controller may monitor the pressure in the container through one or more sensors. In addition or in the alternative, the controller may maintain the pressure in the container and/or the system for recirculating the vented fuel by actuating the pump. In further embodiments, the system for recirculating the vented fuel may include a fuel compressor downstream from the check valve and in fluid communication with the fuel delivery system. In this manner, the vented fuel flows from the check valve into the fuel compressor. As a result, the pressure of the vented fuel may be boosted prior to flowing the vented fuel back into the fuel delivery system. Although exemplary embodiments of the present invention will be described generally in the context of a system for recirculating a vented fuel to a fuel delivery system of a gas turbine for purposes of illustration, one of ordinary skill in the art will readily appreciate that embodiments of the present invention may be applied to any fuel delivery system and are not limited to a fuel delivery system of gas turbine unless specifically recited in the claims.

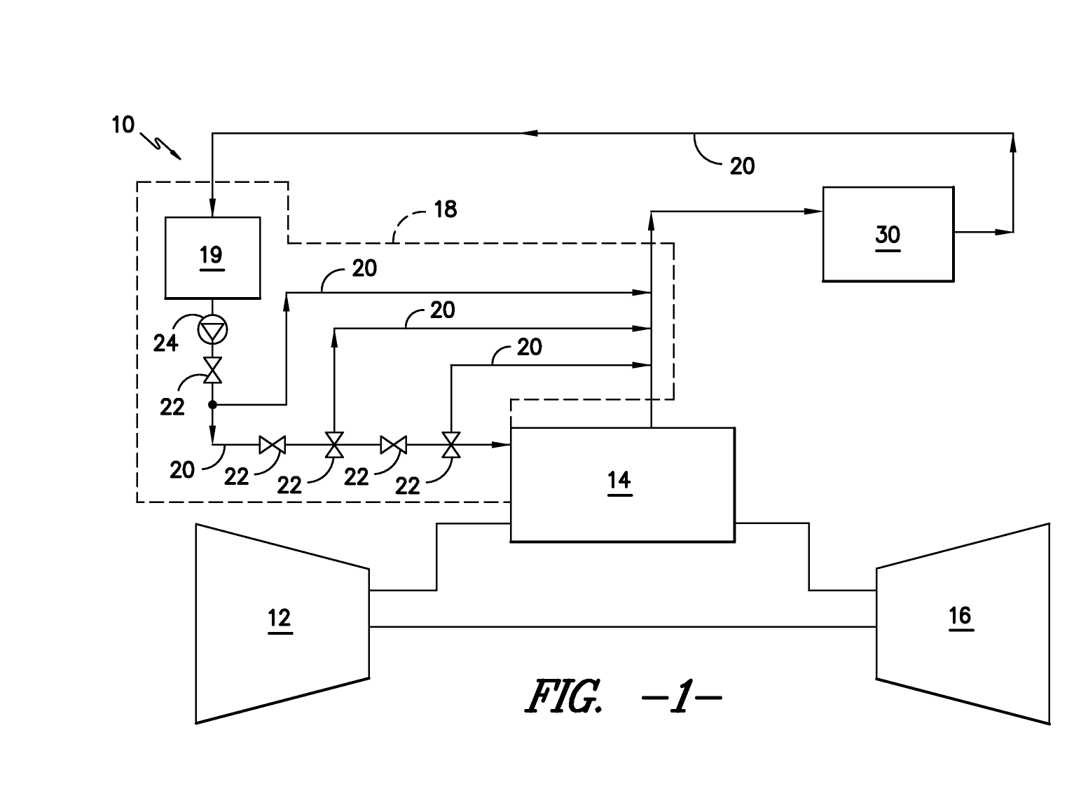

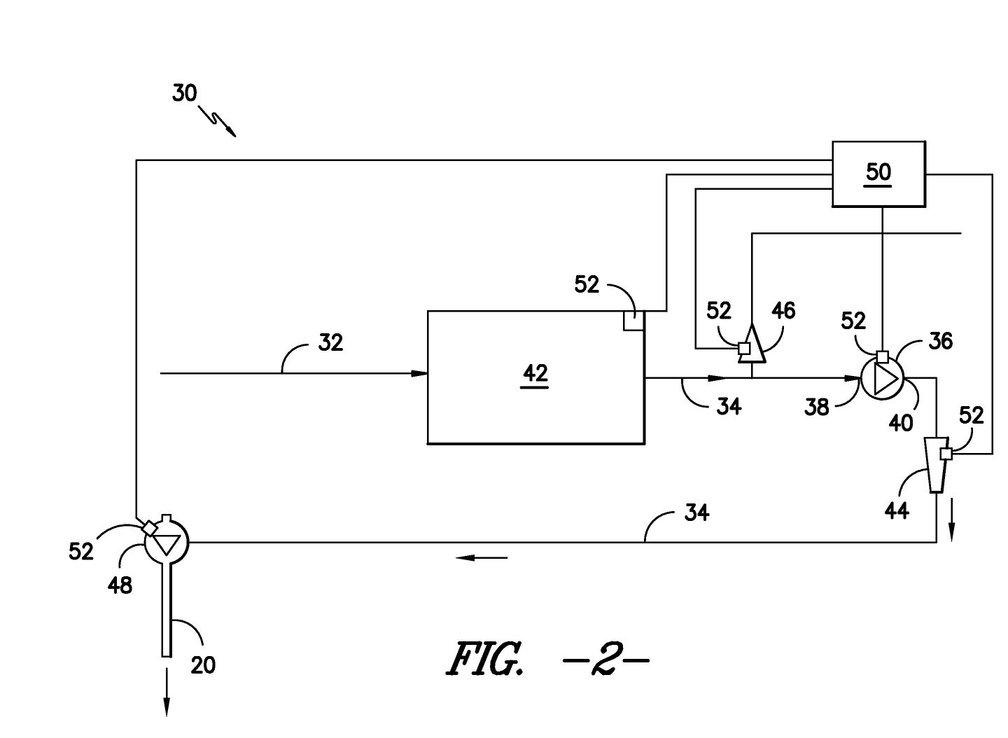

FIG. 1 provides a schematic of a gas turbine including a system for recirculating a vented fuel to a fuel delivery system, according to the present disclosure, and FIG. 2 provides a schematic of the system for recirculating a vented fuel to a fuel delivery system according to one embodiment of the present disclosure. As shown in FIG. 1, the gas turbine 10 may include a compressor 12, a combustor 14 in fluid communication with the compressor 12 and a turbine 16 downstream and in fluid communication with the combustor 14. Although a single combustor 14 is shown, the gas turbine 10 may include a plurality of combustors 14 in fluid communication with the turbine 16. The gas turbine 10 may also include a fuel delivery system 18 in fluid communication with the combustor 14. The fuel delivery system 18 generally includes a fuel source 19, multiple fluid conduits 20, multiple valves 22 and at least one pump 24 for flowing a pressurized fuel from the fuel source 19 to the combustor 14. In particular embodiments of the present invention, as shown in FIGS. 1 and 2, a system for recirculating the vented fuel to the fuel delivery system 30, herein referred to as “the recirculation system 30” may be coupled to the fuel delivery system 18 through one or more of the one or more fluid conduits 20. The recirculation system 30 generally includes a vented fuel conduit 32 coupled to the one or more fluid conduits 20 that provides fluid communication between the fuel delivery system 18 and the recirculation system 30.

In operation, a working fluid, such as air, flows through the compressor 12 to provide a compressed working fluid to the combustor 14. The pressurized fuel flows from the fuel delivery system 18 into the combustor 14. The compressed working fluid is mixed with the pressurized fuel and ignited within the combustor 14, thereby creating a rapidly expanding hot gas. The hot gas flows from the combustor 14 to the turbine 16. As the hot gas flows through the turbine 16, kinetic energy from the hot gas is transferred to a plurality of turbine buckets (not shown) attached to a turbine shaft causing the turbine shaft to rotate and produce mechanical work. The mechanical work produced may drive the compressor 12 or other external loads, such as a generator (not shown) to produce electricity. In certain instances, such as a controlled shut down of the gas turbine 10, and/or a rapid and uncontrolled shutdown of the turbine 16, the pressurized fuel may be vented from the fuel delivery system 18 and/or the combustor 14 through one or more of the one or more fluid conduits 20 coupled to the fuel supply system 18 and to the recirculation system 30. In this manner, the vented fuel may be collected and recirculated back to the fuel delivery system 18.

One or more of the one or more fluid conduits 20 providing fluid communication from the fuel delivery system 18 to the recirculation system 30 may be coupled to the fuel delivery system 18 at any point where it may be undesirable to hold the pressurized fuel once the fuel flow to the combustor 14 has stopped. For example, one or more of the one or more fluid conduits 20 may be connected between an emergency stop vale and an auxiliary stop valve of the fuel delivery system, between the auxiliary stop valve and a gas control valve of the fuel delivery system and/or to an emergency stop valve of the fuel delivery system.

The various embodiments of the present invention include means for streaming the vented fuel to the fuel delivery system. As used herein, the function “streaming the vented fuel to the fuel delivery system” includes flowing, moving, passing, channeling, routing, guiding, driving, pushing, feeding and/or recirculating the vented fuel to the fuel delivery system. As shown in FIG. 2, the means for streaming the vented fuel to the fuel delivery system 18 may include one or more fuel conduits 34 and a pump 36. The one or more fuel conduits 34 may be of any size, shape or material suitable for flowing a fuel therethrough. For example, the one or more fuel conduits 34 may include rigid pipe, flexible hose and/or bendable tubing. In alternate embodiments, the means may include multiple pumps 36. The pump 36 may include any type of pump configured to flow a fuel from a point upstream from the pump 36 to a point downstream from the pump 36. For example, the pump 36 may include a vacuum pump, a positive displacement pump, a reciprocating pump, a rotary pump, a single acting pump, a double acting pump, a twin screw pump, a three screw pump, a multi-staged industrial gear pump, an axial compressor, a centrifugal pump or any combination of the aforementioned pumps. The pump 36 may generally include an inlet 38 and an outlet 40. However, in alternate embodiments, the pump 36 may include multiple inlets 38 and/or multiple outlets 40. In addition or in the alternative, the pump 36 may be configured to create and/or hold a negative pressure upstream from the pump 36 inlet 38.

As shown in FIG. 2, the recirculation system 30 may generally include a container 42 in fluid communication with the vented fuel conduit 32. At least one of the one or more fuel conduits 34 provides fluid communication from the container 42 to the pump 36 inlet 38. The container 42 may be any type of container suitable to contain a pressurized fuel and/or maintain a negative pressure within the container 42. For example, the container 42 may include a pressure vessel. In alternate embodiments, the container 42 may be configured for removal from the recirculation system 30 to store the vented fuel for reintroduction to the fuel delivery system 18 at a later time. The at least one of the one or more fuel conduits 34 may be connected to the pump 36 outlet 40 to provide fluid communication between the pump 36 and the fuel delivery system 18. In particular embodiments, a check valve 44 may be disposed downstream from the pump 36 to provide one-way fluid flow from the pump 36 outlet 40 to the fuel delivery system 18. The check valve 44 may be connected to the pump 36 outlet 38 and the fuel delivery system 18 through one or more of the one or more fuel conduits 34. The check valve 44 may be any type of check valve known in the industry which prevents a fluid from reversing flow. For example, the check valve 44 may include a stop check valve, a lift check valve, a ball check valve, a diaphragm check valve, a swing check valve or any combination thereof.

The recirculation system 30 may also include a vent valve 46 disposed downstream from the container 42. The vent valve 46 may be any type of valve that may allow the vented fuel to flow away from the recirculation system 30. For example, the vent valve may be a normally closed (NCC) valve. In this manner, the vent valve 46 would remain closed during normal operation of the recirculation system 30. However, under certain operating conditions, such as overpressure of the container 42 or contamination of the vented fuel, the vent valve 46 may open to allow the vented fuel to flow away from the recirculation system 30. In particular embodiments, the vent valve 46 may be disposed between the container 42 and the pump 36 inlet 38.

In alternate embodiments, the recirculation system 30 may further include a fuel compressor 48 disposed downstream from the pump 36 outlet 40 and/or the check valve 44 and upstream from the fuel supply system 18. In this manner, the vented fuel may flow from the pump 36 outlet 40 and/or the check valve 44, through one or more of the one or more fuel conduits 34, through the fuel compressor 48 and into the fuel supply system 18. The fuel compressor 48 may include any fuel compressor suitable for compressing and flowing a fuel. For example, the fuel compressor 48 may include a single and/or a multiple stage booster pump or an axial fluid compressor.

In further embodiments, the recirculation system 30 may include a controller 50. The controller 50 may be any controller suitable for receiving an input, such as one or more signals from one or more sensors, and generating an output based at least partially on the input signal. For example, the output signal may include a command signal to an electro-mechanical device and/or a status signal to a reader device, such as a monitor. In particular embodiments, the controller 50 may be a programmable logic controller (PLC). In further embodiments, the controller 50 may be operably connected to at least one of the container 42, the vent valve 46, the pump 36, the check valve 44 or the fuel compressor 48.

In addition, the recirculation system 30 may include one or more sensors 52 operably coupled the controller 50 and to at least one of the container 42, the vent valve 46, the pump 36, the check valve 44 or the fuel compressor 48. The sensors 52 may be configured to sense temperature, pressure, volumetric flow rate or any operating parameter of the system and to communicate a corresponding signal to the controller 50 for processing. For example, in one embodiment, the one or more sensors 52 may sense an excessive pressure in the container 42. The sensor 52 would then communicate the pressure through a signal to the controller 50. As a result, the controller 50 may communicate a command signal to open the vent valve 46 to reduce the pressure within the container 42. In a further example, the one or more sensors may monitor the pressure of the container to maintain a negative pressure. If the pressure in the container rises above a predetermined level, the sensor would communicate the pressure through a signal to the controller 50. As a result, the controller 50 may communicate a command signal to activate the pump 36 to draw the pressure within the container 42 back down to a desired level. As a further example, the one or more sensors 52 may monitor the functionality of the pump 36. If the one or more sensors 52 were to detect a pump failure, the one or more sensors 52 would communicate the failure through a signal to the controller 50. As a result, the controller 50 may communicate a command signal to activate the vent valve 46 to vent the vented fuel away from the recirculation system 30.

The various embodiments as shown in FIG. 2 may also provide a method for recirculating the vented fuel to a fuel delivery system 18. The method generally includes flowing the vented fuel into the container 42, pumping the vented fuel from the container 42 through the pump 36 downstream from the container 42, and flowing the vented fuel from the pump 36 through one or more of the one or more fuel conduits 34 that provide fluid communication between the pump 36 and the fuel delivery system 18. The method may also include flowing the vented fuel from the pump 36 through the check valve 44 disposed downstream from the pump 36.

The various embodiments shown and described with respect to FIG. 2 provide one or more technical advantages over existing systems designed to flow vented fuel. For example, the negative pressure maintained in the container 42 by the pump 36 ensures that the vented fuel from the fuel delivery system 18 will flow into the container 42 once the fuel delivery system 18 is shut down and the fuel is vented. In addition, the pump 36 provides a driving force to move the vented fuel through the one or more fuel conduits 34 back to fuel delivery system 18. In this manner, the recirculated vented fuel may be utilized for generating thermal energy within the combustor. As a result, the overall environmental impact to the atmosphere may be decreased and the cost to fuel the gas turbine may be reduced.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for recirculating a fuel to a fuel delivery system, the system comprising:
a. a vented fuel conduit in fluid communication with the fuel delivery system;
b. a container in fluid communication with said vented fuel conduit;
c. a pump downstream from said container; and
d. a fuel conduit downstream from said pump, wherein said fuel conduit provides fluid communication from said pump to the fuel delivery system.

2. The system as in claim 1, further comprising a check valve downstream from said pump.

3. The system as in claim 1, further comprising a controller operably coupled to at least one of said container or said pump.

4. The system as in claim 3, further comprising one or more sensors coupled to said controller and to at least one of said container or said pump, wherein said sensors are configured to communicate one or more signals between said controller and at least one of said container or said pump.

5. The system as in claim 2, wherein at least one of said one or more sensors is a pressure sensor.

6. The system as in claim 1, further comprising a vent valve downstream from said container.

7. The system as in claim 6, further comprising a controller operably coupled to said vent valve, wherein said controller is configured to communicate a signal to said vent valve at a predetermined pressure value.

8. The system as in claim 1, further comprising a fuel compressor downstream from said pump and upstream from the fuel delivery system.

9. A system for recirculating a vented fuel to a fuel delivery system of a combustor, the system comprising:
a. a vented fuel conduit in fluid communication with the fuel delivery system;
b. a container in fluid communication with said vented fuel conduit; and
c. means for streaming the vented fuel to the fuel delivery system, wherein the means is in fluid communication with said container.

10. The system as in claim 9, wherein the means for streaming the vented fuel comprises a pump downstream from said container.

11. The system as in claim 10, further comprising a controller operably connected to said pump.

12. The system as in claim 9, further comprising a vent valve downstream from said container.

13. The system as in claim 12, further comprising a controller operably connected to said vent valve.

14. The system as in claim 9, further comprising a check valve downstream from said container.

15. The system as in claim 9, further comprising a fuel compressor downstream from said container.

16. The system as in claim 9, further comprising a controller operably connected to said container.

17. The system as in claim 16, further comprising a sensor operably connected to said container and to said controller, wherein said sensor is configured to communicate one or more signals between at least one of said container or said pump to said controller.

18. The system as in claim 17, wherein the sensor is a pressure sensor.

19. A method for recirculating a vented fuel to a fuel delivery system, the method comprising:
a. flowing the vented fuel into a container downstream from the fuel delivery system;
b. pumping the vented fuel from said container through a pump downstream from said container; and
c. flowing the vented fuel from said pump through a fuel conduit;
d. wherein the fuel conduit provides fluid communication between the pump and the fuel supply system.

20. The method of claim 19, further comprising flowing the vented fuel from said pump through a check valve downstream from the pump.
